(19) United States
(12) Patent Application Publication
(10) Pub. No.: US 2026/0086400 A1
(43) Pub. Date: Mar. 26, 2026

(54) SLIM DISPLAY PANEL WITH ACCENT LIGHTING

(71) Applicant: Everi Games Inc., Austin, TX (US)

(72) Inventor: Daniel Gibson, Austin, TX (US)

(73) Assignee: Everi Games Inc., Austin, TX (US)

(21) Appl. No.: 18/896,882

(22) Filed: Sep. 25, 2024

(51) Int. Cl. G02F 1/1333; F21V 8/00; F21Y 113/00; F21Y 115/10; G07F 17/32

(52) U.S. Cl. CPC G02F 1/133317; G02B 6/0051; G02B 6/0073; G02B 6/0088; G02F 1/133331; G07F 17/3211; F21Y 2113/00; F21Y 2115/10

(57) ABSTRACT

A display panel includes a video display and an accent light assembly. The accent light assembly includes a light source posterior to a front cover glass and anterior to the video display. The light source is directly posterior to an opaque area along the front cover glass. A light diffuser for the light source is anterior to the light source and posterior to the front cover glass. The light diffuser extends from under the opaque area into an area behind the first transparent area.

### TECHNICAL FIELD OF THE INVENTION

The invention relates to display panels having accent lighting along at least one edge, and gaming machines that contain the same.

### BACKGROUND

Gaming machines, such as slot machines deployed in a casino floor, often use LED (light emitting diode) strips or panels to provide accent lighting effects. In the gaming industry, attractive lighting is important to attracting players to the gaming machines. In this regard, trim lights around gaming monitors have become common in casinos and gaming rooms. One area of lighting that has seen relatively little innovation in the past decade is the accent or trim LED lighting around gaming monitors. This trim lighting is positioned on the trim of the gaming monitor because the trim lighting takes up little space and helps to frame the monitor.

In many existing trim lighting designs, a liquid crystal display (LCD) provides gaming content and interaction. Currently, the trim lighting extends well beyond the width of the LCD on sides where the trim lighting is used. The conventional configuration provides that a series of LEDs used for the trim lighting is secured within the display panel housing such that the LED is in a position beyond the edge of the LCD and positioned behind (posterior to along the depth dimension) the LCD at the base of the panel. The LED shines forward in a direction toward the anterior side of the display panel through an empty space formed under a transparent area abutting the edge of the panel. The empty space is present because the series of LEDs is mounted along the back frame of the panel, thus necessitating it be offset from the LCD video display assembly because otherwise the series of LEDs would be behind the LCD assembly which would block the light. The light from the series of LEDs moves in a direction toward the front cover glass, striking a light diffuser that may abut a transparent area of the front cover glass. The light from the LEDs pipes forward through the diffuser to provide trim illumination on the face of the gaming device.

The inventors have recognized that a problem with current the trim lighting configuration is that it increases both the height and width of gaming monitors considerably given the space and size restrictions often imposed in casinos. Because many gaming jurisdictions limit game monitor width to 28 inches, the inventors have recognized that this poses a problem for larger gaming monitors. Not only does the extra light trim take up more space and block other electronic gaming machine (EGM) lighting, but it can also push some monitors beyond the 28-inch threshold, notably for 55-inch gaming monitors.

The inventors have thus identified that a need exists to reduce either the width or height or both of trim lighting used in gaming machines.

### SUMMARY

A display panel and gaming machine are described providing an accent lighting arrangement that provides solutions to the problems identified by the inventors.

According to a first aspect of the invention, a display panel includes a housing with one or more frames defining at least left and right edges of the display panel. The display panel also includes a front cover glass positioned in front of the housing and defining a front surface of the display panel. A video display is positioned within the housing and includes a display area visible through a central viewing area of the front cover glass. A first accent light assembly is positioned inside the display panel housing along an edge thereof, located posterior to the front cover glass and anterior to the video display, and includes a series of LEDs and a diffuser positioned between the series of LEDs and the front cover glass. A first opaque area is formed along a back surface of the front cover glass adjacent to the first accent light assembly, and separates the central viewing area of the front cover glass from a first outer transparent area of the front cover glass. The first opaque area is positioned in front of the series of LEDs and an inner portion of the diffuser, with an outer portion of the diffuser extending from behind the first opaque area into an area viewable through the first outer transparent area for carrying light from the series of LEDs to the first outer transparent area.

According to another aspect, a display panel includes a video display and an accent light assembly. The accent light assembly includes a light source posterior to a front cover glass and anterior to the video display. The light source is directly posterior to an opaque area along the front cover glass. A light diffuser for the light source is anterior to the light source and posterior to the front cover glass. The light diffuser extends from behind the opaque area into an area behind the first transparent area.

In some implementations of the above aspects, the first outer transparent area of the front cover glass extends from the first opaque area to the edge of the front cover glass.

In some implementations of the above aspects, the first accent light assembly, the first opaque area, and the first outer transparent area may be located along the left edge of the display panel, and with a second accent light assembly, a second opaque area, and a second outer transparent area located along the right edge of the display panel and constructed similarly to the first accent light assembly, the first opaque area, and the first outer transparent area. The display panel may include a third accent light assembly, a third opaque area, and a third outer transparent area located along a top edge of the display panel and constructed similarly to the first accent light assembly, the first opaque area, and the first outer transparent area.

In some implementations of the above aspects, the first accent light assembly is mounted along a frame element which is attached to one of the frames of the housing and extends inward to a location behind the first opaque area to hold the first accent light assembly. The series of LEDs is mounted along one or more elongated printed circuit boards (PCBs). The front cover glass may be affixed to the frame element with an adhesive located along an edge interior to the first accent light assembly and behind an inner portion of the first opaque area. The video display may be a liquid crystal display (LCD) including an LCD layer positioned posterior to the first accent light assembly, a light guide panel positioned posterior to the LCD layer with a diffuser film between the light guide panel and the LCD layer, and an LED light source positioned at left and right edges of the light guide panel. The LCD may include a plastic frame between edges of the LCD layer and edges of the diffuser film, the plastic frame including an extension with a corner that abuts a corner of the frame element. The one or more frames of the housing may include an inner frame carrying the light guide panel and LED light source, and an outer frame positioned to sandwich portions of the plastic frame and the frame element between the outer frame and the inner frame.

In some implementations of the above aspects, the diffuser of the first accent light assembly extends horizontally with respect to the front cover glass from an area behind the first opaque area, extends behind the entire width of the first outer transparent area, and has an outer edge in line with the outer edge of the front cover glass such that light from the diffuser is visible through the front cover glass and along the outer edge of the diffuser. Display panel where the first opaque area has a width no greater than 15 mm along the back surface of the front cover glass, and the first outer transparent area has a width no greater than 5 mm along the back surface of the front cover glass.

According to another aspect of invention, a gaming machine includes a gaming machine cabinet, a button panel presented along a ledge at a front side of the gaming machine cabinet, and a display panel implemented according to the above aspects and their various implementations.

According to another aspect of the invention, other display devices such as slot machine topper signs or promotional displays may include a display panel implemented according to the above aspects and their various implementations.

Advantageously, the configuration of the accent light assembly of this invention helps to minimize the width and depth of the display panel because the light source for the trim lighting, such as one or LEDs, is mounted directly below the opaque area of the front cover glass and above the height of the video display device. The configuration thus affords a compact display panel which delimits the display panel from becoming too wide.

### BRIEF DESCRIPTION OF THE DRAWINGS

FIG. 1 illustrates a representative display panel having a front cover glass over a video display device with trim lighting along the edges of a display panel.

FIG. 2 illustrates a cross-sectional view of a portion of the representative display panel 100 of FIG. 1 taken along the line I-I in FIG. 1.

FIG. 3 is a block diagram showing the various components that may be included in a gaming machine in accordance with embodiments of this invention.

FIG. 4 is a perspective view of a gaming machine installation including a representative display panel installed in a cabinet.

FIG. 5 is a cross-sectional view of a display panel of the prior art.

FIG. 6 is a cross-sectional view oriented like that of FIG. 2 showing a portion of a display panel according to another embodiment.

FIG. 7 is a cross-sectional view oriented like that of FIG. 2 showing a portion of a display panel according to another embodiment.

FIG. 8 is a cross-sectional view oriented like that of FIG. 2 showing a portion of a display panel according to another embodiment.

FIG. 9 is a cross-sectional view oriented like that of FIG. 2 showing a portion of a display panel according to another embodiment.

### DESCRIPTION OF REPRESENTATIVE EMBODIMENTS

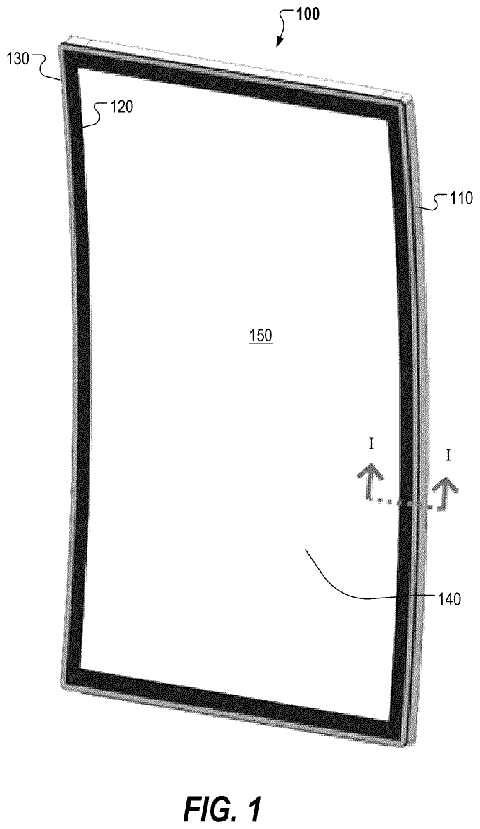

FIG. 1 shows a representative display panel 100. Display panel 100 includes a display panel housing generally indicated by reference number 100, in which there are installed a video display device and internal components of the accent lighting assembly. Display panel 100 includes a front cover glass 140 which covers the entire front face of display panel 100 in this embodiment. As used herein, the front face of the display panel is in a position anterior to the interior of the display panel, with the far side of display panel 100 being the posterior side. The furthest posterior area can also be referred to as the “back,” while the most anterior part of the display panel having the front cover glass can also be referred to as the “front.” As used herein, moving along a path generally parallel to the front cover glass can be referred to as a “horizontal” direction.

Front cover glass 140 may be composed of any transparent material that allows an image projected from the internal video display device, such as an LCD, to pass through so that the image is clearly seen by an observer facing the front of display panel 100. For example, front cover glass 140 can be made of various plastics, though typically the front cover glass is made of glass. Front cover glass 140 includes an opaque area 120 along at least one side adjacent to an edge 110 of display panel 100. Opaque area 120 can be, for example, 15 mm wide black screenprint on the back of front cover glass 140. However, it should be appreciated that any color or combination of colors can be screen printed onto, or otherwise applied to, front cover glass 140. Opaque area 120 should be sufficiently opaque to totally block light from the video display device or light from the accent lighting assembly from passing through opaque area 120. Likewise, opaque area 120 can be screenprint, paint, or an inlay of any opaque solid such as metal, appropriately tinted plastic, or wood. In this embodiment, opaque area 120 serves to frame the image projected from the video display device, which in operation is visible in the central viewing area of display panel 100, that is, the area surrounded by opaque area 120. Opaque area 120 also serves to partition the front of display panel 100 into an inner transparent area 150 that is the central viewing area of the display through which the video display device is visible, and at least one outer transparent area. As used herein, terms such as “inner” and “outer” refer two-dimensionally, from the edges 110 of display panel 100 to its central viewing area at inner transparent area 150. Opaque area 120 also defines an outer transparent area 130 through which accent lighting is visible. Outer transparent area 130 is positioned outward from the central viewing area of front cover glass 140 and outward from opaque area 120 so that the outer transparent area 130 abuts the edge 110 of display panel 100.

The depicted edge 110 corresponds to at least a portion of the display panel 100's housing that forms a side of display panel 100. Display panel 100 has a depth measured from the back of the display panel to the front, which is the front cover glass. As used herein, the light from the video display device projects forward from inside display panel 100 through front cover glass 140.

Transparent area 130 defines where light from the accent (trim) lighting assembly shines through. Thus, transparent area 130 can also be referred to as the trim lighting area, and forms a visual “bezel” or frame for display panel 100 including accent lighting.

In operation, as viewed from the front of the display panel, an observer sees a central game display on video display in inner transparent area 150 that is framed by opaque area 120, which is itself framed by transparent area 130. When in operation, the observer would see the game graphics from the video display through the inner transparent area 150 with trim lighting transmitted through the outer transparent area 130 next to the edge 110 of display panel 100.

In various embodiments, the display panel can have a wide variety of shapes and sizes, such as rectangular, square, round, oval, triangular, and so on. Display panel 100 includes at least one opaque area 120 on front cover glass 140 along at least one edge 110 of the housing. While the embodiment depicted in FIG. 1 shows a rectangular display panel 100 including front cover glass 140 with transparent areas 130 along each side of the rectangle, transparent area 130 could also be along only one side, two sides, or three sides. Similarly, any number of transparent areas 130 can be employed for other shapes. It should also be appreciated that multiple light sources can project through the outer transparent lighting area and that the apparatus may include different color light sources which can be alternately turned on.

In other embodiments, there are multiple opaque areas 120 such that multiple transparent areas 130 occur outward from the middle of the front cover glass 140 toward edges 110.

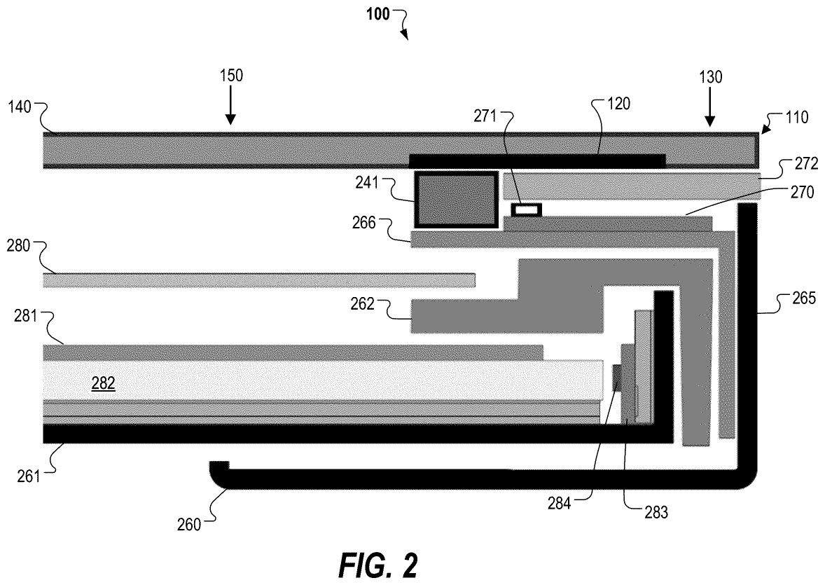

FIG. 2 illustrates a cross-sectional view of a portion of the representative display panel 100 of FIG. 1 taken along the line I-I in FIG. 1. In the orientation of the depicted cross section, front cover glass 140 is shown at the top, with the back of display panel 100 at the bottom. The housing of display panel 100 includes two external frames in this embodiment, an outer metal frame 260 and an inner metal frame 261. Outer metal frame 260 provides the side edges of display panel 100 and may also be formed with top and bottom edges. Outer metal frame 260 and inner metal frame 261 both serve to support display panel 100 and its internal components, directly or indirectly.

Internal housing elements include an internal frame 262 and an internal frame element 266 which provide additional support for the overall structure and support various components. Internal frame 262 is made of plastic, and internal frame element 266 is made of metal. Front cover glass 140 is attached to internal frame element 266 using adhesive such as double-sided tape 241, though it should be appreciated that any suitable method or material can be used to mount front cover glass 140. Preferably, double-sided tape 241 is a double-sided pressure-sensitive adhesive (PSA) tape. While a space is depicted at the front and back of double-sided tape 241, this is merely for clarity and the front and back are touching the adjacent elements when constructed. Front cover glass 140 includes inner transparent area 150, opaque area 120 which is screen printed on the inner, back side of the front cover glass 140, and an outer transparent area 130 next to the edge 110 of display panel 100. While opaque area 120 is shown with a rectangular cross section within front cover glass 140, this is only for emphasis, and typically opaque area 120 is relatively thinner front-to-back (vertically in the orientation of FIG. 2) than illustrated and printed along the glass surface.

A video display is mounted within display panel 100, and in this embodiment is an LCD display including an LCD layer 280, a diffuser film 281, a light guide panel 282, an LED light source 284, and a PCB 283. Various driving and power circuitry is also included but not illustrated to simplify the drawing. LCD layer 280 provides video imagery, and is backlit by light from LED light source 284. Diffuser film 281 diffuses light from the light guide panel 282. The video display components are mounted in outer metal frame 260 and inner metal frame 261. It should be appreciated, however, that any type of video display devices can also be employed, such as an organic LED (OLED) monitor display. Some video displays may not require backlighting. The LCD layer 280 is mounted to the internal frame 262, which can be made of a material such as a plastic.

Display panel 100 includes an accent light assembly, having a light source 271 mounted to an LED PCBA 270 that is mounted to an internal frame element 266. PCBA refers to printed circuit board assemblies. LED PCBA 270 may be mounted with a strip of pressure-sensitive adhesive (PSA) tape. Internal frame element 266 is constructed of a suitable metal such as aluminum. In this embodiment, light source 271 is an elongated physical series of LEDs arranged along the edge to present a “strip” or line of light visible through front cover glass 140 along transparent area 130. It should be appreciated that multiple LEDs are connected to LED PCBA 270 and that strips of LEDs can be employed to construct light source 271, though these are not seen in the cross-section view of FIG. 2. Light source 271 is positioned directly behind opaque area 120. The accent light assembly further includes a light diffuser 272 which is positioned, along the front-to-back dimension, anterior to light source 271 and posterior to front cover glass 140. Light from light source 271 shines forward (vertically in the drawing orientation) into light diffuser 272, which pipes or diffuses the light horizontally through light diffuser 272 towards the edge 110 and diffuses it forward through front cover glass 140. Light emitted by light diffuser 272 can be seen by an observer from the outer transparent area 130 as well as from the side of light diffuser 272 under the front cover glass 140 along the edge 110. Placement of light source 271 directly under the outer transparent area 130 is avoided in this embodiment because light from certain LEDs is too intense, causing hot spots due to inadequate diffusion. In some embodiments, reflective tape (not shown) is applied to the back side of opaque area 120, or the front side of light diffuser 272 along the area of light diffuser 272 opposite the back of opaque area 120, so that light from light diffuser 272 is reflected back into light diffuser 272 along this area.

Display panel 100 includes at least one LED PCBA 270 holding a series of LEDs for light source 271, and may include a plurality of LED PCBA 270 along the edge 110 of display panel 100, depending on the size, shape, and needs for a given end use. While in this embodiment PCBA's are used, other suitable LED light strip designs such as polyimide flexible circuits may be used to construct light source 271. By “series of LEDs” it is meant that the LEDs are arranged in a physical series such that they form a lighting strip, not an electrical series. The LEDs are driven in parallel by individual driver chips which drive a single LED or a combination of red, green, and blue LEDs in a common package (an RGB LED package) which has controllable intensity and color. The circuitry of the accent light assembly may be formed using standard driver chips, arranged in a signaling series to form a round robin signaling bus, and supplied with power according to known LED strip designs. In some embodiments, LED series has a circuit design implemented like that in co-pending U.S. patent application Ser. No. 18/375,357, filed Sep. 29, 2023, in order to increase the number of LEDs which can be effectively used together in a series. U.S. patent application Ser. No. 18/375,357 is incorporated by reference herein in its entirety.

Because light source 271 is directly posterior to opaque area 120 of the front cover glass 140 and anterior to the LCD layer 280, minimal space from the front to the back (vertical in this perspective) of display panel 100 is used to provide for the trim lighting emanating from the outer transparent area 130. Likewise, the configuration in FIG. 2 does not extend the width of display panel 100 in the horizontal direction because internal support frames have little or no gap with the outer side wall 265 of outer metal frame 260.

In this embodiment, light diffuser 272 extends horizontally with respect to front cover glass from an area behind the first opaque area, extends behind the entire width of the first outer transparent area, and has an outer edge in line with the outer edge of the front cover glass such that light from the diffuser is visible through the front cover glass and along the outer edge of the diffuser. Also mounted along LED PCBA 270 are LED driver chips for each LED, and various resistors and other circuit components. Traces on LED PCBA 270 carry power and control signaling for each LED in the series. Such driver and power circuitry are known in the art and are not shown for clarity.

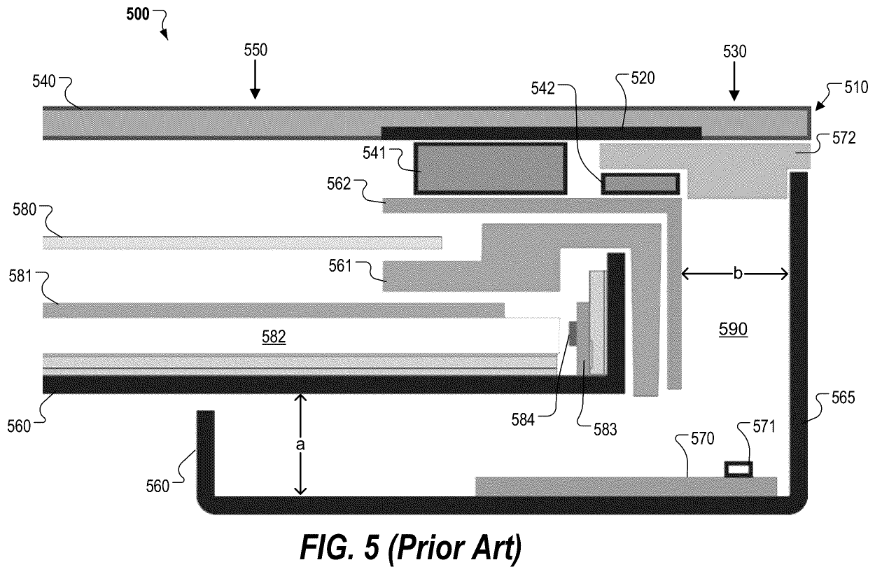

The embodiment shown in FIG. 2 can be contrasted with the prior art configuration shown in FIG. 5, which is not representative of the invention. Panel 500 includes a front cover glass 540, opaque area 520, and outer transparent area 530 extending to edge 510, inner transparent area 550 wherein front cover glass 540 is mounted to internal frame 562 using, for example, double-sided tape 541. Panel 500 also includes a display device composed of an LCD 580 mounted to internal frame 561, diffuser film 581, light guide panel 582, LED 584, and LED PCBA 583 for the light guide panel. Unlike the apparatus of FIG. 2, the light source 571 used for the accent lighting is mounted to a LED PCBA 570 that is mounted to the posterior of the lighted gaming housing 560 having outer side wall 565 and positioned to shine upward in the anterior direction through an empty space 590 to a light diffuser 572, which is mounted to internal frame 562 using for example double-sided tape 542. The light from light source 271 passes forward (vertically in the orientation of the drawing) through outer transparent area 530 of front cover glass 540. In the configuration shown in FIG. 5, the front-to-back depth (vertical in the orientation of FIG. 5) of panel 500 extends a distance “a,” thus increasing the depth and size of panel 500. Likewise, because light source 571 is mounted on the base of panel 500, empty space 590 is needed so that the light can travel forward to reach the light diffuser 572, thus disadvantageously extending the width of panel 500, which is illustrated through extended width illustrated by distance “b.”

Relative to the prior art configuration of FIG. 5, display panel 100 in FIG. 2 is compact, being narrower by eliminating extended width “b” and being not as deep by eliminating depth distance “a.” In one example embodiment, display panel 100 has a 55-inch video display. When arranged in a portrait orientation as shown in FIG. 1, the 55-inch display panel is able to be constructed with a width of 28 inches, from the right edge to the left edge of front cover glass 140. A bezel area including the opaque area and the outer transparent area at the sides of the display panel is reduced in width, providing a slimmer, more attractive display panel. In this embodiment, opaque area 120 is 15 mm wide, and outer transparent area 130 is 5 mm wide, and, as such, the present design enables dimensions no greater than these. Such widths are typically not achievable for a 55-inch monitor using the prior art designs. The total width of such a 55-inch monitor is reduced by 0.35 inches per side if the depicted structure of FIG. 2 is used along both sides of display panel 100. Such a width reduction is especially important for casino slot machine gaming panels because some jurisdictions include width limits of 28 inches for gaming machines. While a 55-inch portrait display is discussed here, the invention may be applied in display panels of other sizes and orientations. Further, while the display panel of FIG. 1 and FIG. 2 is curved, the design of FIG. 2 and variations thereof may also be used in flat display panels. A touchscreen sensor may also be included, typically located along the back of front cover glass 140.

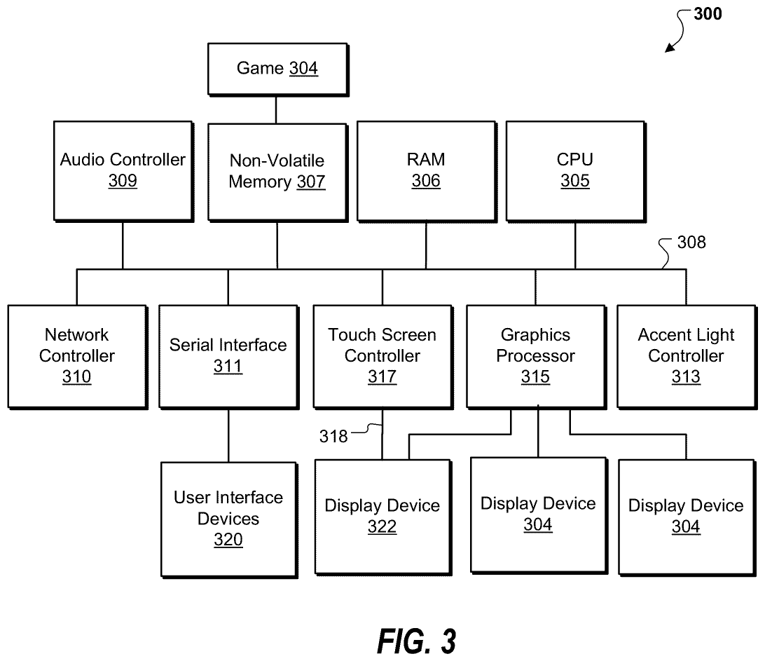

FIG. 3 shows a hardware block diagram of a gaming machine constructed with a display panel 100 according to another example embodiment. Gaming machine 300 includes a processor (CPU) 305 along with a suitable connection to random access memory (RAM) 306. CPU 305 and a non-volatile memory device 307 are connected on a system bus 308 with an audio controller device 309, a network controller 310, a serial interface 311, and a graphics processor 315. Graphics processor 315 may provide a suitable video output to video display devices included on the gaming machine such as video display devices and touch screen display device mounted on the button deck of a gaming machine. Multiple graphics processors may be required depending upon the number of display devices included on the gaming machine. As shown in FIG. 3, a gaming machine also includes a touch screen controller 317 connected to system bus 308. Touch screen controller 317 is also connected via signal path 318 to receive signals from a touch screen element (not shown) associated with a video display device 322.

Those familiar with data processing devices and systems will appreciate that other basic electronic components will be included in a gaming machine such as a power supply, cooling systems for the various system components, audio amplifiers, and other devices that are common in gaming machines. These additional devices are omitted from the drawings so as not to obscure the present invention in unnecessary detail.

All of the elements 305, 306, 307, 308, 309, 310, and 311 shown in FIG. 3 are elements commonly associated with a personal computer, although they may be specially designed and configured for use in a gaming environment. These elements may be mounted on one or more circuit boards housed within a cabinet with or without a separate enclosure. Those familiar with data processing systems and the various data processing elements shown in FIG. 3 will appreciate that many variations on this illustrated structure may be used within the scope of the present invention. For example, since serial communications are commonly employed to communicate with a touch screen controller such as touch screen controller 317, the touch screen controller may not be connected on system bus 308, but instead include a serial communications line to serial interface 311 (a USB controller for example). It will also be appreciated that some of the devices shown in FIG. 3 as being connected directly on system bus 308 may in fact communicate with the other system components through a suitable expansion bus. Audio controller 309, for example, may be connected to the system via a PCI or PCIe bus or bus configured according to some other expansion bus standard. System bus 308 is shown in FIG. 3 merely to indicate that the various components are connected in some fashion for communication with CPU 305 and is not intended to limit the invention to any particular bus architecture.

Numerous other variations in the gaming machine internal structure and system may be used without departing from the principles of the present invention. For example, a gaming machine in some embodiments of the present invention may rely on one or more data processors located remotely from the gaming machine itself. Embodiments of the present invention may include no processor such as CPU 305 or graphics processor such as 315 at the gaming machine and may instead rely on one or more remote processors. Thus, unless specifically stated otherwise, the designation “gaming machine” is used in this disclosure and the accompanying claims to designate a system of devices that operate together to provide the indicated functions. A “gaming machine” may include a gaming machine that is itself a system of various components and may also include one or more components remote from a gaming machine cabinet. As used herein, the designation “gaming machine” encompasses both a stand-alone gaming machine and a gaming machine along with one or more remote components for providing various functions (such as identifying prizes for a given play and controlling result display graphics and performing other operations).

It will also be appreciated that graphics processors are also commonly a part of modern computer systems. Although separate graphics processor 315 is shown for controlling display devices 304 and 322, CPU 305 or a graphics processor packaged with or included with CPU 305 may control all of the display devices directly without any separately packaged graphics processor. The invention is not limited to any particular arrangement of processing devices for controlling the display devices included with gaming machine. Also, a gaming machine implementing the present invention is not limited to any particular number of video display devices or other types of display devices. While display devices 304 and 322 are shown in the example implementation, the display device area may be arranged differently than the portrait orientation shown or may be an area of a single display device.

Control of display devices 304 and 322 will include a suitable driving signal for driving the respective display. Such a driving signal may include any video signal format or standard that the respective display device is adapted to receive. For example, a DisplayPort, HDMI, or DVI signal may be used to drive a respective one of the displays to provide the desired images. Of course, each display will commonly receive operating power separately from the display driving signal.

In the gaming machine, CPU 305 executes software, that is, program code, that ultimately controls the entire gaming machine including the receipt of player inputs and the presentation of the graphics or information displayed through the display devices 304 and 322 and any other display devices associated with the gaming machine. CPU 305 also executes software related to communications handled through network controller 310, and software related to various peripheral devices such as those connected to the system through audio controller 309, serial interface 311, and touch screen controller 317. CPU 305 may also execute software to perform accounting functions associated with game play. Random access memory 306 provides memory for use by CPU 305 in executing its various software programs while the nonvolatile memory device 307 may comprise mass storage device providing storage for game software (program code) prior to loading into random access memory 306 for execution, or for programs and program assets not in use or for other data generated or used in the course of gaming machine operation. Network controller 310 provides an interface to other components of a gaming system in which gaming machine may be included.

It should be noted that the invention is not limited to gaming machines employing the specially configured general purpose processing devices and personal computer-type arrangement of processing devices and interfaces shown in example gaming machine. Other gaming machines through which the invention may be implemented may include one or more special purpose processing devices to perform the various processing steps for implementing the invention.

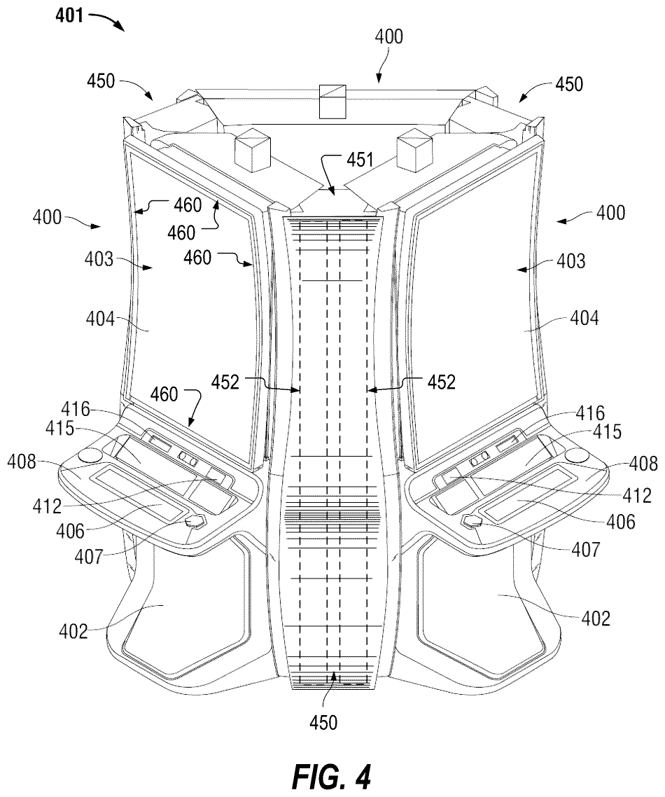

Accent light controller 313 is coupled to the accent light assembly described with respect to FIG. 2, and sends control signals to control the color, intensity of each LED in accent light assembly in a time varying lighting presentation, which is coordinated for particular games played on the machine and game events occurring during game play. Accent light controller 313 may also control accent lighting presentations of other LED strip and light panels associated with the gaming machines, such as accent light columns 452 (FIG. 4). Although the invention is not limited to any particular accent light assembly or control system thereto, accent light assemblies may be controlled conveniently through serial communications to an accent light assembly controller. Thus, some embodiments of the present invention that employ an accent light assembly may use a serial interface device such as serial interface 311 to control communications with an accent light assembly and may not include a direct bus interconnection as indicated by FIG. 3.

FIG. 4 shows gaming machine installation 401 including three gaming machines 400 connected so that the gaming machines face outwardly in a triangular arrangement. In this installation a light panel 450 is positioned in an operating position between each gaming machine 400 in position to provide lighting effects between the two adjacent gaming machines. It should be appreciated that while FIG. 4 shows an installation with three connected gaming machines, display panel 100 of this invention can be installed in a stand-alone gaming machine, side-by-side gaming machines, or any desired configuration.

Each gaming machine 400 (“electronic gaming machine”, “EGM”) in FIG. 4 includes a cabinet 402 having a front side generally shown at reference numeral 403. A primary video display device 404 is mounted in a central portion of the front side 403, and a touch-screen button panel 406 is positioned below the primary video display device. The primary video display device 404 is a display panel 100 of FIGS. 1 and 2 that has been installed in cabinet 402. Along the edges of display device 404 are one or more accent light devices including one or more LED strips 460 of the accent light assembly of this invention, which are typically integrated behind bezels positioned along the left, right, top, and bottom of display device 404. The LED strips 460 also provide accent lighting controlled by accent lighting controller 313. In this regard, the LED strips 460 may be connected in series and controlled with a single control channel, or each controlled with a separate control channel by an accent light controller.

Gaming machine 400 may include additional smaller auxiliary display devices (not shown) in the area shown generally at 408. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 404, may be used to display graphics associated with a reel-type game and bonus game portion in accordance with aspects of the present invention. It is also possible for gaming machines within the scope of the present invention to include mechanical elements such as mechanical reels. Generally, the display device or display devices of the gaming machine, through which games may be presented may be referred to in this disclosure and the accompanying claims as a “display system” regardless of whether the display arrangement includes video displays, physical reels, or combinations of the two.

Each gaming machine 400 illustrated for purposes of example in FIG. 4 also includes a mechanical control button 407 mounted adjacent to touch-screen button panel 406. This control button 407 may allow a player to make a play input to start a play in a wagering game conducted through gaming machine 400, while virtual buttons included (but not shown in this view) on button panel 406 or other physical buttons or controls (not shown) may allow a player to select a bet level for a game implemented at the gaming machine and select a type of game or game feature. Touch-screen button panel 406 may also be used in implementations of reel-type games encompassing aspects of the invention to allow the player to control a cursor that may be displayed on another display device. Other forms of gaming machines through which the invention may be implemented may include switches, joysticks, or other mechanical input devices, in addition to the virtual buttons and other controls implemented on touch-screen button panel 406. For example, primary video display device 404 in gaming machine 400 provides a convenient display device for implementing touch screen controls in addition to or in lieu of controls included on touch-screen button panel 406 or mechanical controls. The player interface devices which receive player inputs in the course of a game played through the gaming machine, such as controls to select a wager amount for a given play, controls to enter a play input to actually start a given play in the wagering game, or controls to allow a player to make other player inputs in a game according to the present invention, may be referred to generally as a “player input system.”

It will be appreciated that gaming machines may also include a number of other player interface devices in addition to devices that are considered player controls for use in entering inputs in the course of a particular game. Gaming machine 400 also includes a currency/voucher acceptor having an input ramp 412, a voucher/receipt printer having a voucher/receipt output 415, and a player card reader (not shown in the view of FIG. 4). Numerous other types of player interface devices may be included in gaming machines that may be used to implement embodiments of the present invention.

Gaming machine 400 may also include a sound system to provide an audio output to enhance the user's playing experience. For example, illustrated gaming machine 400 includes speakers behind grille 416 which may be driven by a suitable audio amplifier (not shown) to provide a desired audio output at the gaming machine.

Light panel 450 includes a light panel front cover generally indicated at 450 and a light panel housing 451 which supports the light panel front cover in an operating position. As shown by the dashed boxes in FIG. 4, light panel 450 includes two accent light columns 452 (which may also be referred to as “external light modules”) extending side-by-side. These two accent light columns 452 are housed within light panel housing 451 and can be controlled by the adjacent gaming machines to provide various backlighting effects visible through the light panel front cover. The two accent light columns 452 are shown in dashed lines to reflect the fact that they are located in this view behind light panel front cover and housed within the light panel housing.

In certain embodiments, each accent light column 452 included in panel 450 is controlled by a different one of the gaming machines 400 through a respective control signal line in and input port. For example, a gaming machine 400 on the right-hand side of panel 450 controls the accent light column 452 on the right-hand side of panel 450 while the gaming machine 400 on the left-hand side of panel 450 controls the left-hand light column of panel 450. The control signals may be the same control signals used to control the EGM-mounted accent lights such as those of an accent light assembly of FIG. 2 in a display panel 100 so that they operate in coordination with the lights included in the adjacent accent light column 452 of the light panel 450.

Light panel 450 may be reconfigurable with different numbers of LED panels installed to provide a different height, width, coloring, or density of lighting along one or more of its accent light columns 452. A particular light panel 450 may be replaced with another light panel 450 of a different size with a different array of LEDs. Accent light controller 313 may optionally have the capability to automatically recognize when a light panel or light column is changed in the field and reconfigure itself to control the new arrangement of LED panels.

An accent light controller such as 313 may include a data communication interface such as serial interface adapted to connect to a communication channel to communicate with LED panels and/or accent lighting assembly of this invention. An accent light controller may also include an electronic controller such as microprocessor which is connected to communicate through serial interface. Memory is a tangible, non-transitory memory such as flash memory holding software with which microprocessor is booted and configured. Stored in memory is an LED panel configuration set and/or accent lighting assembly including data needed to recognize accent lighting light sources and configure accent light controller to command and control LED panels and LEDs in accent lighting assemblies in various configurations.

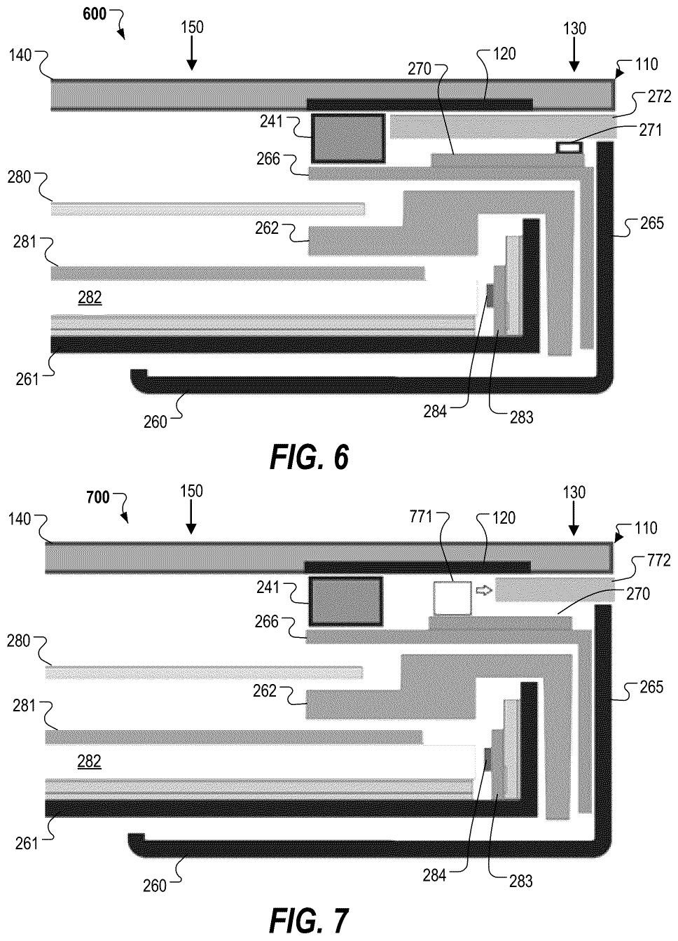

FIG. 6 is a cross-sectional view oriented like that of FIG. 2 showing a portion of a display panel 600 according to another embodiment. The features include the same reference numbers as the embodiment of FIG. 2, and are constructed similarly except for differences discussed here. In this embodiment, light source 271 is repositioned such that it is located immediately behind outer transparent area 130. The hotspot effect discussed above may be mitigated in this embodiment by using a series of LEDs for light source 271 less bright than that of the embodiment of FIG. 2, or using a light diffuser 272 with a lower transmittance rating.

FIG. 7 is a cross-sectional view oriented like that of FIG. 2 showing a portion of a display panel 700 according to another embodiment. The features include the same reference numbers as the embodiment of FIG. 2, and are constructed similarly except for differences discussed here. In this embodiment, a different light source 771 replaces light source 271, and a light diffuser 772 is constructed with a smaller width (the side-to-side dimension in this orientation) than light diffuser 272. Light source 771 is constructed with a series of LEDs that are side emitting such that the light is directed out of each LED package into the inner end of light diffuser 772 as depicted by the arrow on FIG. 7.

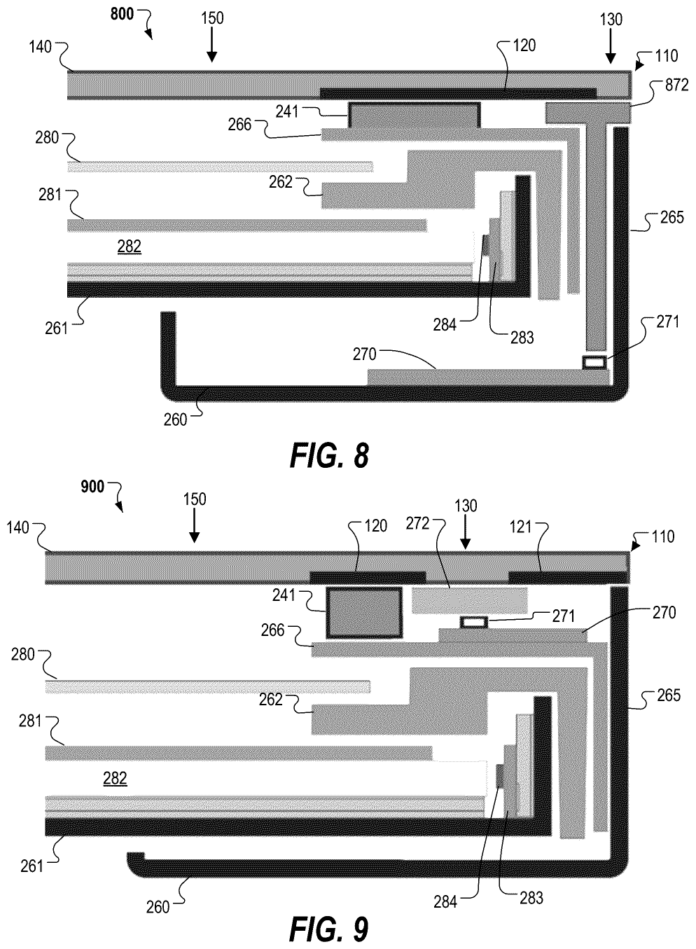

FIG. 8 is a cross-sectional view oriented like that of FIG. 2 showing a portion of a display panel 800 according to another embodiment. The features include the same reference numbers as the embodiment of FIG. 2, and are constructed similarly except for differences discussed here. In this embodiment, light diffuser 272 is replaced with a light pipe 872, and light source 271 is relocated to the back of display panel with its LED PCBA 270 mounted along the interior side of outer metal frame 260. Light pipe 872 is made of a clear, highly transparent material like acrylic or polycarbonate, and constructed with a T-shape such that the outer edge presented at edge 110 of display panel 800 is able to emit a portion of the light from light source 271. Light pipe 872 is mounted between outer side wall 265 and internal frame element 266, and allows a smaller side-to-side dimension as compared to dimension “b” shown in FIG. 5. In this embodiment, double-sided tape 241 has a larger width than that of FIG. 2, making the depicted design suitable for use with display panels having a larger or heavier front cover glass to avoid delamination.

FIG. 9 is a cross-sectional view oriented like that of FIG. 2 showing a portion of a display panel 900 according to another embodiment. The features include the same reference numbers as the embodiment of FIG. 2, and are constructed similarly except for differences discussed here. A additional opaque area 121 is added to the back side of front cover glass 140, constructed similarly to opaque area 120. Opaque area 121 separates outer transparent area 130 from the edge 110, with no lighting projected laterally from edge 110 in this embodiment.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as front, back, upper, lower, right, and left and the like with reference to a given feature are made with reference to the orientation of the display panel, gaming machines, or gaming machine installation shown in the drawings.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above-described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A display panel comprising:
a housing including one or more frames defining at least left and right edges of the display panel;
a front cover glass positioned in front of the housing and defining a front surface of the display panel;
a video display positioned within the housing and including a display area visible through a central viewing area of the front cover glass;
a first accent light assembly positioned inside the display panel housing along an edge thereof, located posterior to the front cover glass and anterior to the video display, and comprising a series of LEDs and a diffuser positioned between the series of LEDs and the front cover glass; and
a first opaque area positioned along a back surface of the front cover glass adjacent to the first accent light assembly and separating the central viewing area of the front cover glass from a first outer transparent area of the front cover glass, wherein the first opaque area is positioned in front of the series of LEDs and an inner portion of the diffuser, and an outer portion of the diffuser extends from behind the first opaque area into an area viewable through the first outer transparent area for carrying light from the series of LEDs to the first outer transparent area.

2. The display panel of claim 1 wherein the first outer transparent area of the front cover glass extends from the first opaque area to the edge of the front cover glass.

3. The display panel of claim 1 wherein the first accent light assembly, the first opaque area, and the first outer transparent area are located along the left edge of the display panel, and further comprising a second accent light assembly, a second opaque area, and a second outer transparent area located along the right edge of the display panel and constructed similarly to the first accent light assembly, the first opaque area, and the first outer transparent area.

4. The display panel of claim 3, further comprising a third accent light assembly, a third opaque area, and a third outer transparent area located along a top edge of the display panel and constructed similarly to the first accent light assembly, the first opaque area, and the first outer transparent area.

5. The display panel of claim 1 wherein the first accent light assembly is mounted along a frame element which is attached to one of the frames of the housing and extends inward to a location behind the first opaque area to hold the first accent light assembly.

6. The display panel of claim 5 wherein the series of LEDs is mounted along one or more elongated printed circuit boards.

7. The display panel of claim 5 wherein the front cover glass is affixed to the frame element with an adhesive located along an edge interior to the first accent light assembly and behind an inner portion of the first opaque area.

8. The display panel of claim 5 wherein the video display is a liquid crystal display (LCD) including an LCD layer positioned posterior to the first accent light assembly, a light guide panel positioned posterior to the LCD layer with a diffuser film between the light guide panel and the LCD layer, and an LED light source positioned at left and right edges of the light guide panel.

9. The display panel of claim 8 wherein the LCD includes a plastic frame between edges of the LCD layer and edges of the diffuser film, the plastic frame including an extension with a corner that abuts a corner of the frame element.

10. The display panel of claim 9 wherein the one or more frames comprise:
an inner frame carrying the light guide panel and LED light source; and
an outer frame positioned to sandwich portions of the plastic frame and the frame element between the outer frame and the inner frame.

11. The display panel of claim 1 wherein the diffuser of the first accent light assembly extends horizontally with respect to the front cover glass from an area behind the first opaque area, extends behind the entire width of the first outer transparent area, and has an outer edge in line with the outer edge of the front cover glass such that light from the diffuser is visible through the front cover glass and along the outer edge of the diffuser.

12. The display panel of claim 1 wherein the first opaque area has a width no greater than 15 mm along the back surface of the front cover glass, and the first outer transparent area has a width no greater than 5 mm along the back surface of the front cover glass.

13. A gaming machine, comprising:
a gaming machine cabinet;
a button panel presented along a ledge at a front side of the gaming machine cabinet; and
a display panel mounted along a front side of the gaming machine cabinet above the button panel and comprising:
a) a housing including one or more frames defining at least left and right edges of the display panel;
b) a front cover glass positioned in front of the housing and defining a front surface of the display panel;
c) a video display positioned within the housing and including a display area visible through a central viewing area of the front cover glass;
d) a first accent light assembly positioned inside the display panel housing along an edge thereof, located posterior to the front cover glass and anterior to the video display, and comprising a series of LEDs and a diffuser positioned between the series of LEDs and the front cover glass; and
e) a first opaque area positioned along a back surface of the front cover glass adjacent to the first accent light assembly and separating the central viewing area of the front cover glass from a first outer transparent area of the front cover glass, wherein the first opaque area is positioned in front of the series of LEDs and an inner portion of the diffuser, and an outer portion of the diffuser extends from behind the first opaque area into an area viewable through the first outer transparent area for carrying light from the series of LEDs to the first outer transparent area.

14. The gaming machine of claim 13 wherein the first outer transparent area of the front cover glass extends from the first opaque area to the edge of the front cover glass.

15. The gaming machine of claim 13 wherein the first accent light assembly, the first opaque area, and the first outer transparent area are located along the left edge of the display panel, and further comprising a second accent light assembly, a second opaque area, and a second outer transparent area located along the right edge of the display panel and constructed similarly to the first accent light assembly, the first opaque area, and the first outer transparent area.

16. The gaming machine of claim 15 further comprising a third accent light assembly, a third opaque area, and a third outer transparent area located along a top edge of the display panel and constructed similarly to the first accent light assembly, the first opaque area, and the first outer transparent area.

17. The gaming machine of claim 13 wherein the first accent light assembly is mounted along a frame element which is attached to one of the frames of the housing and extends inward to a location behind the first opaque area to hold the first accent light assembly.

18. The gaming machine of claim 17 wherein the front cover glass is affixed to the frame element with an adhesive located along an edge interior to the first accent light assembly and behind an inner portion of the first opaque area.

19. The gaming machine of claim 17 wherein:
the video display is a liquid crystal display (LCD) including an LCD layer positioned posterior to the first accent light assembly, a light guide panel positioned posterior to the LCD layer with a diffuser film between the light guide panel and the LCD layer, and an LED light source positioned at left and right edges of the light guide panel; and
the LCD includes a plastic frame between edges of the LCD layer and edges of the diffuser film, the plastic frame including an extension with a corner that abuts a corner of the frame element.

20. The gaming machine of claim 17 wherein the diffuser of the first accent light assembly extends horizontally with respect to front cover glass from an area behind the first opaque area, behind the entire width of the first outer transparent area, and has an outer edge in line with the outer edge of the front cover glass such that light from the diffuser is visible through the front cover glass and along the outer edge of the diffuser.
